(19) United States
(12) Patent Application Publication
(10) Pub. No.: US 2014/0078403 A1
(43) Pub. Date: Mar. 20, 2014

(54) SYSTEM AND METHOD FOR BROADCAST RECEPTION MANAGEMENT

(71) Applicants: Don Joslyn, DeBary, FL (US); Santosh Hari, Lake Mary, FL (US); Peter Stanforth, Winter Springs, FL (US)

(72) Inventors: Don Joslyn, DeBary, FL (US); Santosh Hari, Lake Mary, FL (US); Peter Stanforth, Winter Springs, FL (US)

(73) Assignee: SPECTRUM BRIDGE, INC., Lake Mary, FL (US)

(21) Appl. No.: 13/623,671

(22) Filed: Sep. 20, 2012

(51) Int. Cl. H04N 5/50

(52) U.S. Cl. 348/731; 348/E05.097

(57) ABSTRACT

A system and method for broadcast reception management. In some embodiments, a database is used to determine the available broadcasts and associated channel numbers for a given location. In other embodiments, a station list is determined for a specified broadcast, the station list comprising a first channel of a first station on which the specified broadcast is broadcast at a first location and a second channel of a second station on which the specified broadcast is broadcast at a second location. The communication circuitry of the wireless electronic device is tuned in accordance with the station list to the first channel in the first location to receive the specified broadcast. The communication circuitry is retuned to the second channel in the second location to continue reception of the specified broadcast.

### TECHNICAL FIELD

The technology of the present disclosure relates generally to wireless communications and, more particularly, to a system and method for broadcast reception management.

### BACKGROUND

The portability of wireless electronic devices is becoming increasingly prevalent, due much in part to their reduction in size and/or integration with other devices. Some wireless electronic devices may include a digital television tuner to wirelessly receive digital television and/or a radio tuner to wirelessly receive analog or digital radio broadcasts. The transmitters used by terrestrial stations are in a fixed location, and therefore provide a limited broadcast range for a given television or radio broadcast.

### BRIEF DESCRIPTION OF THE DRAWINGS

FIG. 1 is a schematic view of an exemplary arrangement of transmitters.

FIG. 2 is a schematic view of an exemplary wireless electronic device.

FIG. 3 is a schematic view of an exemplary broadcast reception system.

FIG. 4 is an exemplary area coverage map of a specified broadcast showing a planned travel route that traverses a first broadcast area and a second broadcast area.

FIGS. 5-7 are flow diagrams representing exemplary actions taken by various components of the broadcast reception system of FIG. 3.

FIG. 8 is an exemplary area coverage map of a specified broadcast showing a travel route that traverses a first broadcast area and a second broadcast area.

FIGS. 9 and 10 are flow diagrams representing exemplary actions taken by various components of the broadcast reception system of FIG. 3.

### DETAILED DESCRIPTION

Embodiments will now be described with reference to the drawings, wherein like reference numerals are used to refer to like elements throughout. It will be understood that the figures are not necessarily to scale. Features that are described and/or illustrated with respect to one embodiment may be used in the same way or in a similar way in one or more other embodiments and/or in combination with or instead of the features of the other embodiments.

### A. INTRODUCTION

In the U.S., the FCC has eliminated analog television (TV) broadcasts in favor of digital TV broadcasts. TV stations now broadcast using digital signals using UHF broadcast bands and VHF broadcast bands in the frequency range of 54 MHz to 698 MHz.

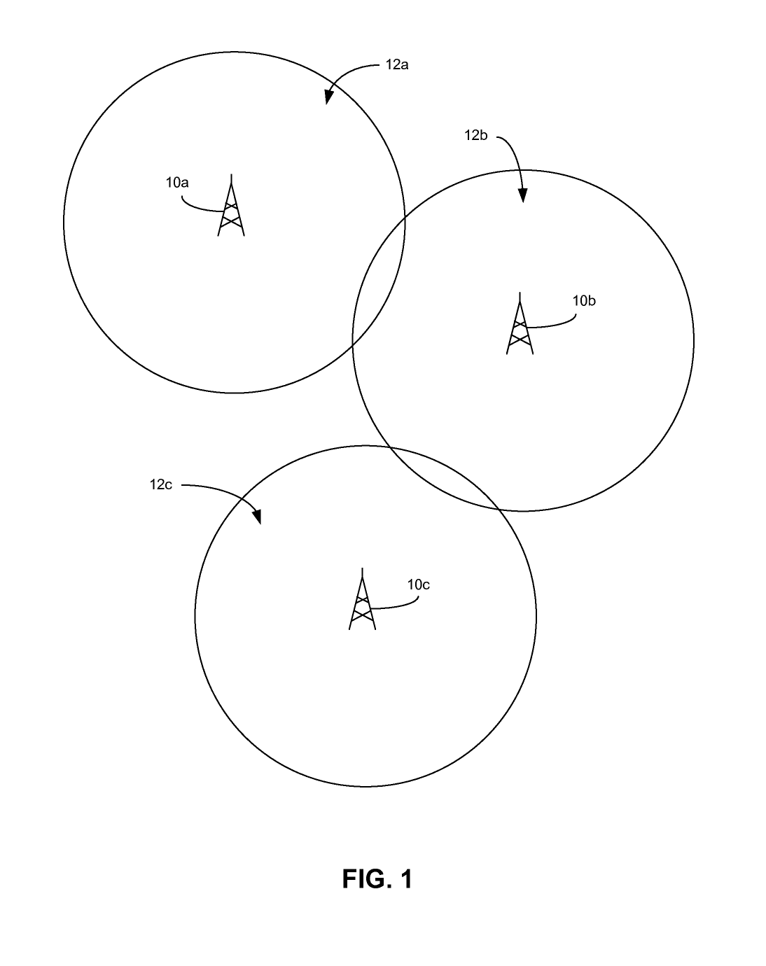

FIG. 1 shows an example of incumbent devices 10a, 10b, 10c embodied as transmitters, each transmitter associated with a local TV station and configured to transmit a digital broadcast. Each transmitter 10a, 10b, 10c is located in a fixed position and has a predetermined broadcast range 12a, 12b, 12c. In the illustrated embodiment, each transmitter 10a, 10b, 10c is affiliated with the same television network. Exemplary television networks in the U.S. include, but are not limited to, the Public Broadcasting Service (PBS), the National Broadcasting Company (NBC), CBS Broadcasting Inc. (CBS), and the American Broadcasting Company (ABC). Although the transmitters of one network are illustrated in FIG. 1, the transmitters of other networks may be displayed with similar overlapping coverage areas. The transmitters may be full-power transmitters, low-power (class A) transmitters, or a mix of transmitter types.

The channel on which the local TV stations broadcast is likely to vary by location in order to minimize the potential for interference. In the present disclosure the term “channel” encompasses a broadcast band (e.g., a UHF TV band, a VHF TV band, a FM radio band, an AM radio band, etc.), as well as one or more sub-channels included as part of a multiplex associated with the broadcast band. In the example shown in FIG. 1, the local transmitters 10a, 10b, 10c may broadcast a given network broadcast on different respective channels. Conventionally, broadcast bands for analog television transmissions were ordered by channel number as the bands increased in frequency. But for digital television broadcast over the same bands, the channel numbers may not be numbered in order according to frequency. Therefore, devices that receive digital broadcasts scan the spectrum for available broadcasts, and will identify the available broadcasts and associated channel numbers received by the device. However, this scanning and identification process is time consuming and is not appropriate for use in connection with mobile devices. Due to the architecture of the digital broadcast system, wireless electronic devices capable of receiving digital broadcasts must perform the scanning and identification process each time the device is moved. For example, a wireless electronic device that has performed the scanning and identification process in a first location must perform another scanning and identification process when moved to a second location. If the wireless electronic device was receiving a broadcast of a given network in the first location, the channel will likely have to be changed to a different channel in order to continue reception of the broadcast in the second location and the new channel will need to be identified using the scanning process.

In accordance with the present disclosure, a database provides information for advising the wireless electronic device of which broadcasts and associated channel numbers are available in a given location. The database may be stored on the wireless electronic device or on a server. By using the database, the device does not have to perform the scanning and identification process. The wireless electronic device may tune to a channel identified by the database while in a first location. The database may also be used to allow the wireless electronic device to maintain reception of the same or a similar broadcast as the wireless electronic device moves to a second location

The above example describes a digital TV broadcast. However, aspects of the disclosed systems and methods are independent of the type of digital or analog broadcast received by a wireless electronic device. It will be appreciated that the techniques described in this document may apply to other forms of broadcast over any suitable form of licensed or unlicensed spectrum (e.g., digital or analog radio broadcast).

### B. WIRELESS ELECTRONIC DEVICE

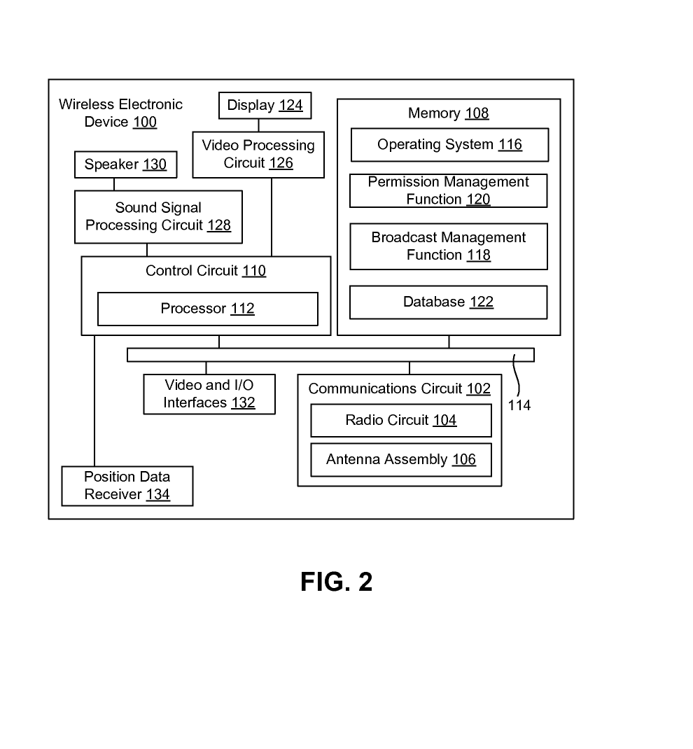

Referring now to FIG. 2, a schematic block diagram of a wireless electronic device is shown at 100. The wireless electronic device 100 may be configured to execute various functions for managing the reception of a broadcast. As discussed in more detail below, the wireless electronic device 100 may be configured to determine the available broadcasts and associated channel numbers for a given location. The wireless electronic device 100 may alternatively or additionally be configured to determine a station list for a specified broadcast, and in accordance with the station list and the location of the wireless electronic device 100, tune to an appropriate channel to receive the specified broadcast. When the wireless electronic device 100 moves to a new location, the wireless electronic device 100 may retune to the channel of another station broadcasting the specified broadcast. Such features allow for seamless reception of the specified broadcast as the wireless electronic device 100 is moved through various broadcast coverage areas. Additionally or alternatively, the wireless electronic device 100 may be configured to manage reception of a specified permission-based broadcast.

The wireless electronic device 100 may be a personal portable device such as, for example, a laptop computer, smart phone, tablet, media player, gaming device, personal digital assistant (PDA), electronic book reader, etc. Other examples of the wireless electronic device 100 include a device integrated or installed in a vehicle (e.g., a digital radio or digital television), or a standalone device.

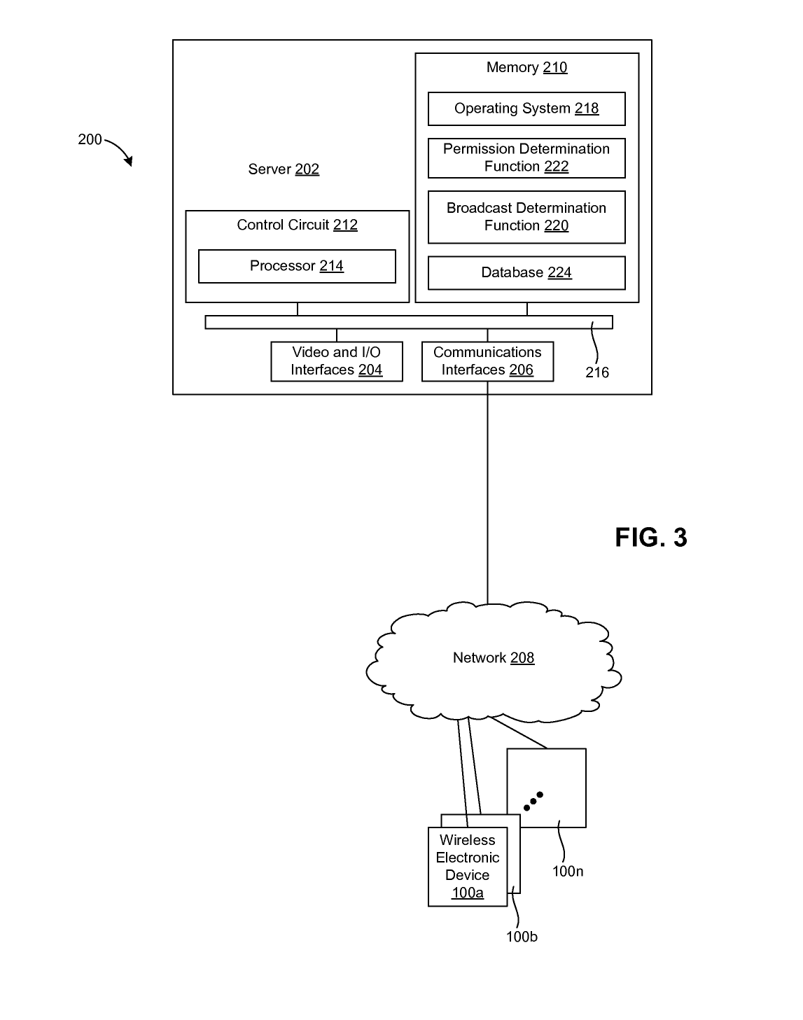

The wireless electronic device 100 may include communications circuitry 102. In the illustrated exemplary embodiment, as part of the communications circuitry 102, the wireless electronic device 100 includes a radio circuit 104 and an antenna assembly 106. The communications circuitry 102 may be used to carry out various wireless communications functions, including receiving a digital broadcast and communicating with the server 202 (FIG. 3).

The illustrated radio circuitry 104 and antenna assembly 106 represents one or more than one radio transceiver to enable the wireless electronic device 100 to be able to communicate and receive signals over various types of network connections and/or protocols. In one embodiment, the communications circuitry 102 includes one or more broadcast tuners, such as a digital TV tuner, an FM radio tuner, an AM radio tuner, a digital radio tuner, etc, as well as a transceiver capable of establishing backchannel communication with the server 202, such as a cellular communications transceiver, or a packet-switched communications transceiver (e.g., Wi-Fi or WiMAX).

The wireless electronic device 100 may include a memory 108 for storing data, logic routine instructions, computer programs, files, operating system instructions, and the like. The memory 108 is considered a non-transitory computer readable medium and may comprise several devices, including volatile and non-volatile memory components. Accordingly, the memory 108 may include, for example, random access memory (RAM) for acting as system memory, read-only memory (ROM), hard disks, floppy disks, optical disks (e.g., CDs and DVDs), tapes, flash devices and/or other memory components, plus associated drives, players and/or readers for the memory devices.

Overall functionality of the wireless electronic device 100 may be controlled by a control circuit 110. The control circuit 110 may include one or more processors 112 used to execute instructions that carry out a specified logic routine(s). The control circuit 110 and the components of the memory 108 may be coupled using a local interface 114. The local interface 114 may be, for example, a data bus with accompanying control bus, a network, or other subsystem.

The memory 108 may store an operating system 116 that is executed by the processor 112 to control the allocation and usage of resources in the wireless electronic device 100, as well as provide basic user interface features. Specifically, the operating system 116 controls the allocation and usage of the memory 108, the processing time of the processor 112 dedicated to various applications being executed by the processor 112, and the peripheral devices, as well as performing other functionality. In this manner, the operating system 116 serves as the foundation on which applications, such as the broadcast management function 118 and/or the permission management function 120, depend as is generally known by those with ordinary skill in the art.

The memory 108 may store a broadcast management function 118. The broadcast management function 118 may be embodied as one or more computer programs (e.g., one or more software applications including compilations of executable code).

The broadcast management function 118 may be configured to determine the available broadcasts and associated channel numbers for a given location. In one example, the broadcast management function 118 may use the database 122 in combination with the location of the wireless electronic device to determine the broadcasts and associated channel numbers at the present location of the wireless electronic device. In another example, the broadcast management function 118 may request a list of the available broadcasts and associated channel numbers at the present location of the wireless electronic device. The broadcast management function 118 may be configured to control the communication circuitry 102 in accordance with the determination of the available broadcasts and associated channel numbers. For example, the broadcast management function 118 may control the communication circuitry 102 to only to those channels associated with available broadcasts.

The broadcast management function 118 may additionally or alternatively be configured to control reception of a specified broadcast as the wireless electronic device 100 moves from one location to another.

The content of the specified broadcast may be content broadcast by one or more transmitters. In the embodiment of TV transmitters, the content of the specified broadcast may be a TV show, a movie, a sporting event, or other programming. Typically, the program content is broadcast by more than one transmitter across a plurality of transmitters that are affiliated with a network. Similarly, in the embodiment of an audio content transmitter (commonly referred to as radio), the content may be a music program, a sporting event, a talk show, a news program, etc. The broadcast management function 118 may be configured to determine a station list for a specified broadcast. As described herein, a station list is a listing of one or more channels associated with a specified broadcast, each channel in the station list associated with a transmitter of a broadcast station that transmits the content of the specified broadcast. In one embodiment, the station list is an ordered list of channel numbers associated with a planned travel route of a wireless electronic device. In another embodiment, the station list is a list of channel numbers associated with the current location of the wireless electronic device. The station list may include information such as geographic coverage area for the transmitters corresponding to each channel number in the station list, a location for each transmitter identified in the station list, identification of an area(s) of overlap in the coverage area of the signals from two or more transmitters, a waypoint for switching from one channel to another, etc.

For example, the station list may include a first station identified as broadcasting the specified broadcast on a first channel at a first location and a second station identified as broadcasting the specified broadcast on a second channel at a second location. As will be explained below, the station list may be compiled using information such as geographic location, a planned travel route, network information, etc.

The broadcast management function 118 may be configured to control the communication circuitry 102 in accordance with the station list. Exemplary embodiments showing the operation of the broadcast management function 118 are described in more detail below.

The memory 108 may store a permission management function 120 that is configured to control reception of a permission-based broadcast. The permission management function 120 may be embodied as one or more computer programs (e.g., one or more software applications including compilations of executable code). The permission management function 120 may determine whether the wireless electronic device 100 is authorized to access a specified permission-based broadcast, and may manage the receipt or display of such broadcast. Such process may be separate from the process of managing broadcast reception in accordance with a determined station list, and may be performed independent therefrom, prior thereto, or concurrent therewith. Exemplary embodiments showing the operation of the permission management function 120 are described in more detail below.

The memory 108 may store a database 122 that stores information used by the broadcast management function 118 and/or the permission management function 120. The database 122 may include information such as a listing of one or more broadcast stations, network affiliation associated with each broadcast station, the genre of each broadcast station, the type of broadcast (e.g., mobile TV standard or fixed TV standard) of each broadcast station, geographic coverage of each broadcast station, one or more decryption keys associated with the authorized wireless electronic devices, etc. The database 122 may also store data regarding reception capabilities of the electronic device 100, such as antenna gain, and data regarding transmission characteristics of the transmitter for each station, such as transmit power antenna height, antenna profile, etc. This information may be used to determine predicted receive signal strengths of the broadcasts from each station at various locations. The database 122 may be downloaded from the server 202 (FIG. 3) and/or may be periodically updated manually or automatically, e.g., using the database stored in the server 202.

The broadcast management function 118 may use the database 122 in determining available broadcasts and associated channel numbers for a given location, in determining the station list, and/or in providing the server (FIG. 3) with information regarding the wireless electronic device 100, e.g., device specifications, geographic location, etc. In another example, the permission management function 120 may use the database 122 in controlling reception of a permission-based broadcast or decrypting an encrypted permission-based broadcast.

The electronic device 100 may include a display 124. The display 124 displays information to a user such as operating state, time, telephone numbers, contact information, various menus, etc., that enable the user to utilize the various features of the electronic device 100. The display 124 also may be used to visually display content received by the electronic device 100. The display 124 may be used to present images, video and other graphics to the user, such as photographs, mobile television content, Internet pages, and video associated with games. The display 124 may be coupled to the control circuit 110 by a video processing circuit 126 that converts video data to a video signal used to drive the display 124. The video processing circuit 126 may include any appropriate buffers, decoders, video data processors and so forth. The video data may be derived from an incoming video data stream that is received by the communications circuitry 102.

The wireless electronic device 100 may include a sound signal processing circuit 128 for processing audio signals received from the communications circuitry 102. Coupled to the sound signal processing circuit 128 is a speaker 130 that enables a user to listen to audio data received by the wireless electronic device 100. The audio data may include, for example, received audio data such as in the form of streaming audio data. The sound signal processing circuit 128 may include any appropriate buffers, decoders, encoders, amplifiers and so forth. A microphone (not illustrated) also may be operatively coupled to the control circuit 110 via the sound signal processing circuit 128.

The wireless radio device 100 may have various video and input/output (I/O) interfaces 132. The (I/O) interfaces 132 may be used to operatively couple the wireless radio device 100 to various peripherals (not shown), such as a display, a keyboard, a mouse, other input devices, a microphone, a camera, a scanner, a printer, a speaker, a power supply, and so forth.

The wireless electronic device may include a position data receiver, such as a global positioning system (GPS) receiver 134. In one embodiment, location of the wireless radio device 100 may be determined using a triangulation method. A common triangulation method is by using a GPS or assisted GPS (AGPS) approximation of location.

### C. BROADCAST RECEPTION SYSTEM

With additional reference to FIG. 3, a schematic block diagram of a broadcast reception system is shown at 200. The broadcast reception system includes a computer-based server 202. As discussed in more detail below, the server 202 may be configured to receive a request for available broadcasts for a given location and send a response including the available broadcasts and associated channel numbers for the given location. Additionally or alternatively, the server may be configured to receive a request for a station list for a specified broadcast from a wireless electronic device 100, generate the station list, and send a response including the station list to the wireless electronic device 100. Additionally or alternatively, the server 202 may be configured to receive an access request from a wireless electronic device 100, determine whether the wireless electronic device 100 is authorized to access a specified permission-based broadcast, and send an access response to the wireless electronic device 100.

The server 202 may have various video and input/output (I/O) interfaces 204 as well as one or more communications interfaces 206. The I/O interfaces 204 may be used to operatively couple the server 202 to various peripherals (not shown), such as a display, a keyboard, a mouse, and/or one or more other suitable input devices. The communications interfaces 206 may include for example, a modem and/or a network interface card. The communications interfaces 206 may enable the server 202 to send and receive data signals, voice signals, video signals, and the like to and from one or more wireless electronic devices 100a-100n via an external network 208 (e.g., the Internet, a wide area network (WAN), a local area network (LAN), direct data link, or similar systems).

The server 202 may include a memory 210 for storing data, logic routine instructions, computer programs, files, operating system instructions, and the like. The memory 210 is considered a non-transitory computer readable medium and may comprise several devices, including volatile and non-volatile memory components. Accordingly, the memory 210 may include, for example, random access memory (RAM) for acting as system memory, read-only memory (ROM), hard disks, floppy disks, optical disks (e.g., CDs and DVDs), tapes, flash devices and/or other memory components, plus associated drives, players and/or readers for the memory devices.

Overall functionality of the server 202 may be controlled by a control circuit 212. The control circuit 212 may include one or more processors 214 used to execute instructions that carry out a specified logic routine(s). The control circuit 212 and the components of the memory 210 may be coupled using a local interface 216. The local interface 216 may be, for example, a data bus with accompanying control bus, a network, or other subsystem.

The memory 210 may store an operating system 218 that is executed by the processor 214 to control the allocation and usage of resources in the server 202, as well as provide basic user interface features. Specifically, the operating system controls the allocation and usage of the memory 210, the processing time of the processor 214 dedicated to various applications being executed by the processor 214, and the peripheral devices, as well as performing other functionality. In this manner, the operating system 218 serves as the foundation on which applications, such as the broadcast determination function 220 and/or the permission determination function 222, depend as is generally known by those with ordinary skill in the art. The operating system 218 also may control much of the user interface environment presented to a user, such as features of the overall graphical user interface (GUI) for the system.

The memory 210 may store a broadcast determination function 220. In one embodiment, the broadcast determination function 220 is embodied as one or more computer programs (e.g., one or more software applications including compilations of executable code).

The broadcast determination function 220 may be configured to provide a wireless electronic device 100 with information about available broadcasts and associated channel numbers for a given location. The broadcast determination function 220 may be configured to determine the available broadcasts and associated channel numbers for the given location in response to a request from a wireless electronic device 100. In an example, the broadcast determination function 220 may determine the available broadcasts and associated channel numbers based on information received from the wireless electronic device 100 with the request, such as the location of the wireless electronic device, identification of the wireless electronic device 100, specification(s) of the wireless electronic device 100, etc.

The broadcast determination function 220 may be configured to provide a wireless electronic device 100 with information for controlling reception of a specified broadcast as the wireless electronic device 100 moves from one location to another. The broadcast determination function 220 may be configured to determine a station list in response to a request from a wireless electronic device 100. In an example, the broadcast determination function 220 may determine the station list based on information received from the wireless electronic device 100 with the request, such as the location of the wireless electronic device, a planned travel route of the wireless electronic device 100, identification of the wireless electronic device 100, specification(s) of the wireless electronic device 100, identification of the specified broadcast, etc.

The broadcast determination function 220 may be configured to collect information from the wireless electronic device 100. For example, the broadcast management function 118 of the wireless electronic device 100 may be configured to provide the server 202 with information about the signal strength of a specified transmitter at a current location of the wireless electronic device 100. Such information may be used to supplement and/or update the database 224.

The broadcast determination function 220 may be configured to periodically supplement and/or update the database 122 of the wireless electronic device 100.

Exemplary embodiments showing the operation of the broadcast determination function 220 are described in more detail below.

The memory 210 may store a permission determination function 222 that is configured to facilitate reception or display of a permission-based broadcast at the wireless electronic device 100. More specifically, the permission determination function 222 may determine whether the wireless electronic device 100 is authorized to access a specified permission-based broadcast. The permission determination function 222 may be embodied as one or more computer programs (e.g., one or more software applications including compilations of executable code). Exemplary embodiments showing the operation of the permission management function 222 are described in more detail below.

The memory 210 may store a database 224 that stores information used by the broadcast determination function 220 and/or the permission determination function 222. The database 224 may include information such as a listing of one or more broadcast stations, network affiliation associated with each broadcast station, genre information associated with each broadcast station, type of broadcast (e.g., mobile TV standard or fixed TV standard) of each broadcast station, geographic coverage of each broadcast station, one or more decryption keys associated with the authorized wireless electronic devices, etc. The database 224 may also store data regarding reception capabilities of the electronic device 100, such as antenna gain, and data regarding transmission characteristics of the transmitter for each station, such as transmit power antenna height, antenna profile, etc. This information may be used to determine predicted receive signal strengths of the broadcasts from each station at various locations.

In some embodiments, the database 224 may be compiled using data from a conventional TVWS database and registration system. The purpose of conventional TVWS database and registration is to determine available stations that may be used by a television band radio device (TVBD) for wireless communications. The information pertaining to the TV transmitters from the conventional TVWS database can be included in the database 224 in order to provide channel information for respective broadcast stations. The database 224 may be supplemented with information related to the respective transmitters, e.g., network affiliations, genre, broadcast schedules, signal strength data provided from the wireless electronic device 100, type of broadcast (e.g., mobile TV standard or fixed TV standard), and/or data from third-party source such as the Federal Communications Commission (FCC). The database 224 may be periodically updated, and may itself be used to update the database 122 of the wireless electronic device 100.

### D. EXEMPLARY EMBODIMENTS OF BROADCAST RECEPTION MANAGEMENT

The wireless electronic device 100 in accordance with the present disclosure, either alone or in cooperation with the server 102, manages broadcast reception at the wireless electronic device 100. The following description provides exemplary embodiments by which broadcast reception management may be executed.

The following exemplary embodiments may be carried out, in part, by executing an embodiment of the broadcast management function 118 and/or an embodiment of the permission management function 120 of the wireless electronic device 100. The following exemplary embodiments may also be carried out, in part, by executing an embodiment of the broadcast determination function 220 and/or an embodiment of the permission determination function 222 of the server 202. Therefore, the following exemplary embodiments represent one or more methods that may be carried out by the wireless electronic device 100 and one or more methods that may be carried out by the server 202. Although the exemplary embodiments show specific orders of executing functional logic blocks, the order of executing the blocks may be changed relative to the order shown. Also, two or more blocks shown in succession may be executed concurrently or with partial concurrence. Furthermore, one or more of the functional logic blocks may be omitted.

In some embodiments, the broadcast management function 118 of the wireless electronic device 100 or the broadcast determination function 220 of the server 202 provides broadcast reception management of the available broadcasts at a given location.

For example, the location of the wireless electronic device may be determined using the GPS of the wireless electronic device 100 (e.g., using a triangulation method). The available broadcasts and associated channel numbers may then be determined using the determined location. In some embodiments, this determination is performed at the wireless electronic device 100. The broadcast management function 118 of the wireless electronic device 100 may use the location of the wireless radio device 100 in combination with information from the database 122 to determine what broadcasts are available at the current location of the wireless electronic device 100. In other embodiments, the determination is performed at the server 202. The broadcast management function 118 of the wireless electronic device 100 may send a request to the server 202, the request including the location of the wireless electronic device 100. The broadcast determination function 220 may use the location of the wireless radio device 100 in combination with information from the database 224 to determine what broadcasts are available at the current location of the wireless electronic device 100. The determination result may be sent by the broadcast determination function 220 and received by the wireless electronic device 100. By utilizing the database at the wireless electronic device 100 or at the server 202, the available broadcasts at a given location are determined without the need to scan the spectrum. Accordingly, this determination may be performed as frequently as desired (e.g., the performance based on a temporal or geographical trigger) without the delays and power consumption associated with spectrum scanning.

In other embodiments, the broadcast determination function 220 provides broadcast reception management of a specified broadcast.

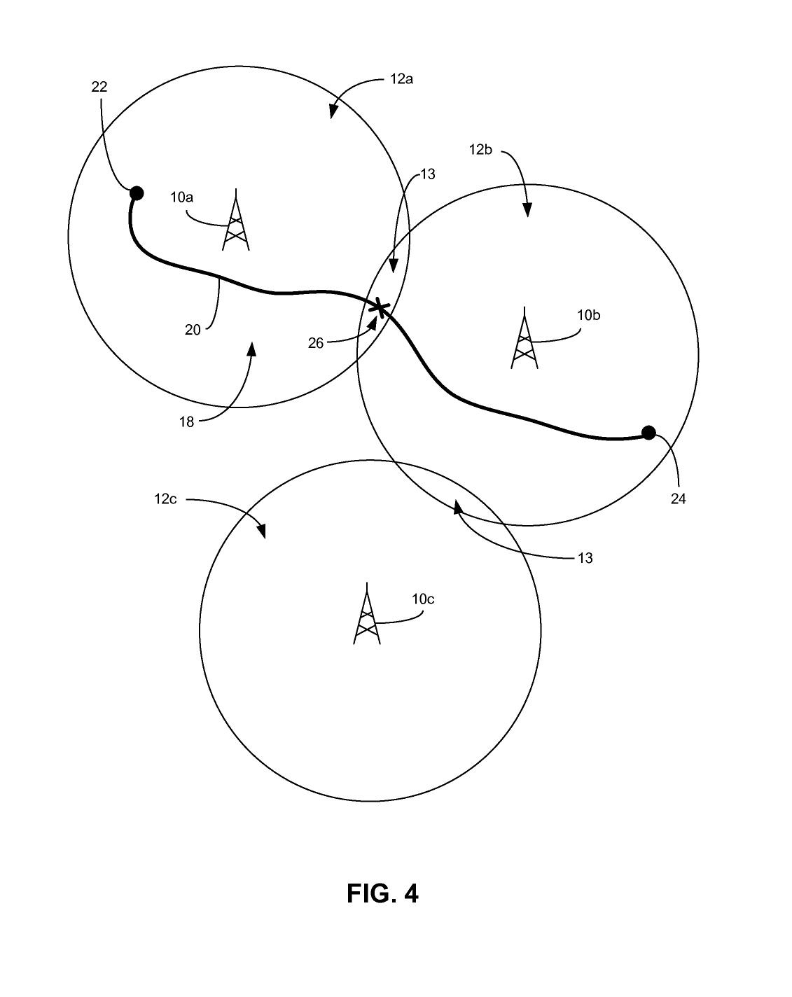

FIGS. 4-7 show an exemplary embodiment for managing receipt of a specified broadcast for a planned travel route. As shown in FIG. 4, the planned travel route 18 follows a path 20 from a starting point 22 to an ending point 24. The user of the wireless electronic device 100 has selected broadcast content to receive during the travel from the starting point 22 to the ending point 24. The broadcast content selected by the user is the specified broadcast. The user of the wireless electronic device may make the specified broadcast selection simply by tuning to the associated content or a channel at a current location of the wireless electronic device. In another embodiment, the user of the wireless electronic device may make the specified broadcast selection by browsing a content guide (e.g., TV listings or radio listings) and using a user interface to make the selection.

For purposes of the present description, the content of the specified broadcast is broadcast by the transmitters 10a, 10b, 10c, which are each affiliated with a single network. In the illustrated example, the path 20 traverses a first broadcast area 12a of the first transmitter 10a and a second broadcast area 12b of the second transmitter 10b. The first broadcast area 12a defines a geographical area in which the specified broadcast is received on a first channel (e.g., channel 3), and the second broadcast area 12b defines a geographical area in which the specified broadcast is received on a second channel (e.g., channel 5). The wireless electronic device 100 will follow the path 20 of the planned travel route 18 and will leave the first broadcast area 12a and enter the second broadcast area 12b. While FIG. 4 shows a planned travel route 18 that traverses two broadcast areas 12a, 12b, in other embodiments the planned travel route may traverse more than or less than two broadcast areas.

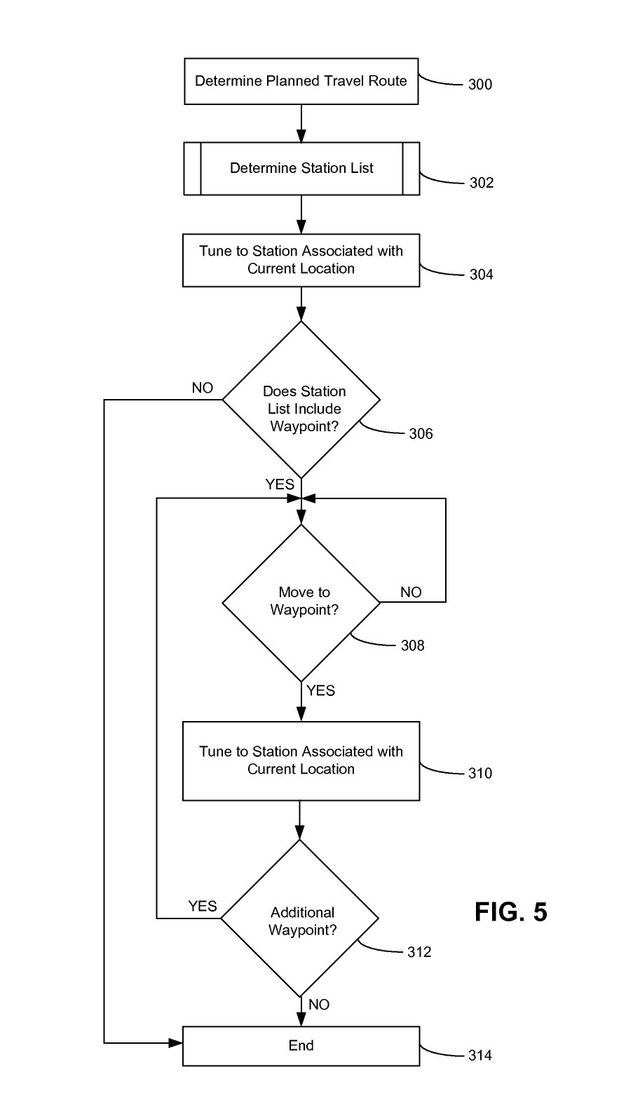

With additional reference to FIG. 5, the broadcast management process may commence in block 300 where the planned travel route is determined. The planned travel route may be determined in any suitable manner. In one exemplary embodiment, the planned travel route is determined using the position data receiver 134 (e.g., GPS) and/or a navigation program that provides directions from the starting point 22 to the ending point 24. The navigation system may be part of the wireless electronic device 100 or may be separate, but in communication with the wireless electronic device 100.

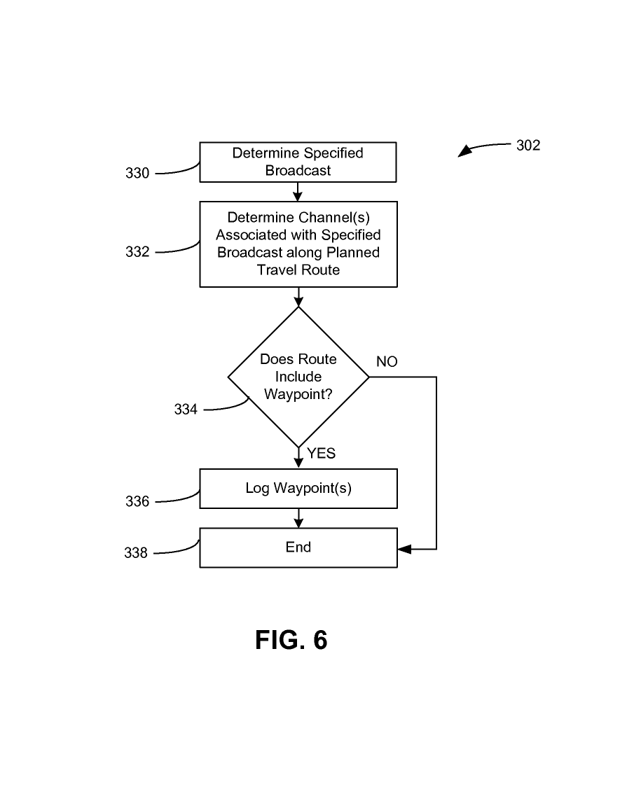

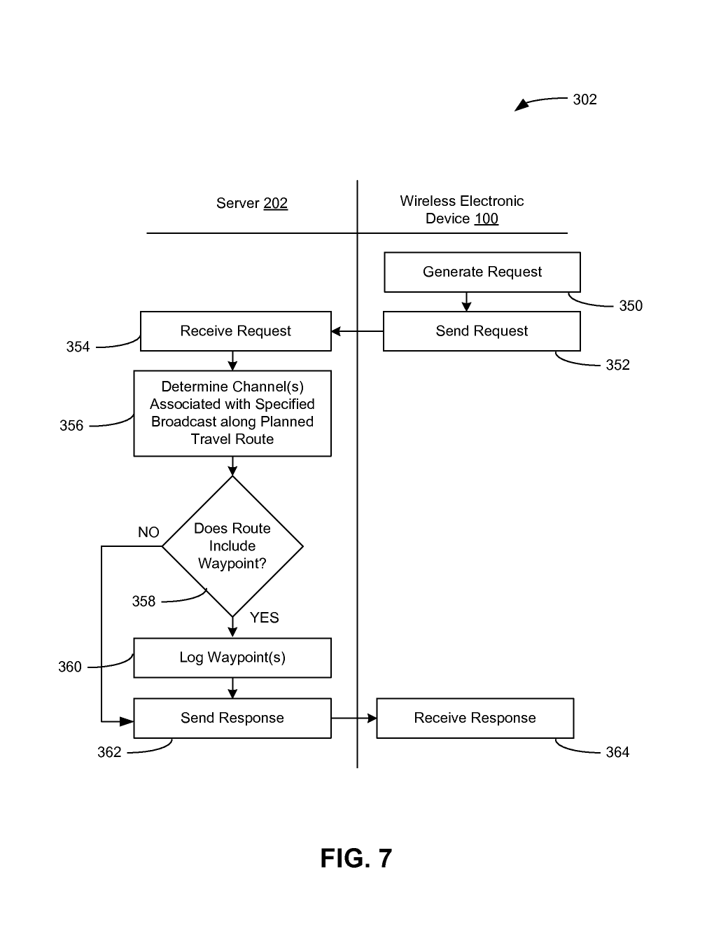

At step 302, the broadcast management function 118 of the wireless electronic device 100 determines the station list based on the planned travel route. In one embodiment, the station list is an ordered list of channel numbers, each channel number in the station list associated with a transmitter of a station that transmits the content of the specified broadcast along the planned travel route. The station list may additionally include the location of one or more waypoints, each waypoint associated with a broadcast coverage overlap of two of the channel number in the station list. In one embodiment, when the wireless electronic device 100 arrives at a waypoint, the wireless electronic device tunes to the successive channel included in the station list. In another embodiment, when the wireless electronic device 100 arrives at a waypoint, the wireless electronic device monitors the actual signal strength of the associated transmitters. FIGS. 6 and 7 describe exemplary embodiments of determining the station list.

Specifically, FIG. 6 shows an embodiment in which the step 302 of determining the station list is performed at the wireless electronic device 100. Specifically, at step 330, the broadcast management function 118 of the wireless electronic device 100 determines the specified broadcast that is to be received. This determination may be performed by using the database 122 of the wireless radio device 100 in combination with information such as the channel that the wireless electronic device is tuned to at the current location, the selection of a channel or network using a content guide (e.g., stored in the database 122 or made available by a third party), etc. The database 122 or a separate content guide may be used to determine a network identity associated with the specified broadcast. For example, it may be identified that NBC is the network affiliated with the specified broadcast.

At step 332, the broadcast management function 118 uses the database 118 to determine the channel(s) associated with transmitters affiliated with the determined network (e.g., NBC) and/or broadcasting the specified broadcast along the planned travel route. As shown in FIG. 4, the specified broadcast is provided on two different channels with different, but overlapping coverage areas, along the planned travel route. Although not specifically shown, in other embodiments, the specified broadcast may be provided on two channels in the same coverage area. For example, the same program may be broadcast using both a mobile TV standard and a fixed TV standard. In such embodiments, the broadcast management function 118 may prioritize one broadcast over another (e.g., the mobile TV standard over the fixed TV standard).

At step 334, the broadcast management function 118 determines whether the planned travel route includes a waypoint 26 (FIG. 4) at which to change from one channel to another channel to maintain reception of the specified broadcast over the entire route 20. Such determination may be calculated from the data that is retained in the database 122. In one embodiment, the specific location of the waypoint(s) is determined using predictive signal strength. Overlap area 13 (FIG. 4) is identified, which represents the overlap in the coverage area of the signals from two or more transmitters 10a and 10b that broadcast the specified broadcast. For each overlap area 13, and for the transmitters 10 corresponding to the overlap area 13, a determination is made as to the point along the path 20 that the predicted signal strength of one transmitter (e.g., the transmitter 10a upstream in the route 20) is less than the predicted strength of another transmitter (e.g., the transmitter 10b downstream in the route 20). This point is deemed to be the waypoint 26. Predicted signal strength may be determined using any appropriate path loss model, such as Longley-Rice, F-curves, etc.

In another embodiment, the presence of a waypoint(s) is identified by the presence of an overlap area 13, and the specific position of the waypoint 26 is determined using actual signal strength of the associated transmitters. Specifically, the wireless electronic device 100 determines each overlap area 13 and each transmitter corresponding to the overlap area 13. When the wireless electronic device 100 enters the overlap area 13, the wireless electronic device 100 monitors signal strength values (e.g., received signal strength indicator RSSI) of the corresponding transmitters. When the actual signal strength of the transmitter associated with the channel presently being received (e.g., the transmitter 10a upstream in the route 20) is less than the actual signal strength of the transmitter associated with a new channel (e.g., the transmitter 10b downstream in the route 20), the wireless electronic device 100 may switch channels to the new channel.

In yet another embodiment, the presence of a waypoint(s) is identified by the presence of an overlap area 13, and the specific position of the waypoint 26 is identified as the middle of the overlap area 13.

If the result of the determination in step 334 is that the planned travel route does not include a waypoint (NO), the process ends at step 338. If the result of the determination is that that the planned travel route does include a waypoint (YES), the process proceeds to step 336 where the broadcast management function 118 logs the geographic location of the waypoint(s) and/or the geographic location of the overlap area(s) 13. While the present example shows one overlap area 13 and waypoint 26, in other embodiments, the broadcast management function 118 may determine more than one overlap area and waypoint and identify the respective geographic locations thereof. The number of overlap areas and waypoints depends on the number of transmitters 10 for a specified broadcast along the planned travel route, as well as factors such as the signal strength of the respective broadcasts along the planned travel route.

FIG. 7 shows an embodiment in which the step of determining the station list 302 is performed using the server.

At step 350, the broadcast management function 118 of the wireless electronic device 100 generates a request for a station list. The request may include information to enable the server 202 to generate the station list. For example, the request may include information such as the planned travel route of the wireless electronic device 100. The request may additionally include one or more of identification information of the wireless electronic device 100, one or more operating parameters of the wireless electronic device 100, information to identify the specified broadcast (e.g., a selection from a content guide hosted by the server, the wireless electronic device, or a third-party system; a selected channel or network; or the channel or network that the wireless electronic device is tuned to at the current location), etc. The request is sent by the wireless electronic device at step 352, and the request is received at the server 202 at step 354.

At step 356, the broadcast determination function 220 uses the database 224 and the planned travel route of the wireless electronic device to determine the channel(s) on which the specified broadcast is broadcast at points along the planned travel route. This determination may be made using any additional information provided in the request. As shown in FIG. 4, the broadcast is provided on two different channels with different, but overlapping coverage areas, along the planned travel route.

At step 358, the broadcast determination function 220 determines whether the planned travel route includes a waypoint 26 (FIG. 4) at which to change from one channel to another channel to maintain reception of the specified broadcast over the entire route 20. Such determination may be calculated from the data that is retained in the database 122. In one embodiment, the specific location of the waypoint(s) is determined using predictive signal strength. Overlap area 13 (FIG. 4) is identified, which represents the overlap in the coverage area of the signals from two or more transmitters 10a and 10b that broadcast the specified broadcast. For each overlap area 13, and for the transmitters 10 corresponding to the overlap area 13, a determination is made as to the point along the path 20 that the predicted signal strength of one transmitter (e.g., the transmitter 10a upstream in the route 20) is less than the predicted strength of another transmitter. This point is deemed to be the waypoint 26 (e.g., the transmitter 10b downstream in the route 20). Predicted signal strength may be determined using any appropriate path loss model, such as Longley-Rice, F-curves, etc.

In another embodiment, the presence of a waypoint(s) is identified by the presence of an overlap area 13, and the specific position of the waypoint is determined using actual signal strength of the associated transmitters. Specifically, the wireless electronic device 100 determines each overlap area 13 and each transmitter corresponding to the overlap area 13. When the wireless electronic device 100 enters the overlap area 13, the wireless electronic device 100 monitors signal strength values (e.g., received signal strength indicator RSSI) of the corresponding transmitters and. When the actual signal strength of the transmitter associated with the channel presently being received (e.g., the transmitter 10a upstream in the route 20) is less than the actual signal strength of the transmitter associated with a new channel (e.g., the transmitter 10b downstream in the route 20), the wireless electronic device 100 may switch channels to the new channel.

In yet another embodiment, the presence of a waypoint(s) is identified by the presence of an overlap area 13, and the specific position of the waypoint 26 is identified as the middle of the overlap area 13.

If the result of the determination in step 334 is that the planned travel route does not include a waypoint (NO), the process proceeds to step 362 where the response is sent to the wireless electronic device 100. In such case, the response includes the channel(s) associated with the specified broadcast along the planned travel route. If the result of the determination is that that the planned travel route does include a waypoint (YES), the process proceeds to step 360 where the broadcast management function 220 logs the geographic location of the waypoint(s) and/or the geographic location of the overlap area(s) 13. The number of overlap areas and waypoints depends on the number of transmitters 10 for a specified broadcast along the planned travel route, as well as factors such as the signal strength of the respective broadcasts along the planned travel route. The process then proceeds to step 362 where the response is sent to the wireless electronic device 100. In such case, the response includes the channel(s) associated with the specified broadcast along the planned travel route, as well as the identification of the one or more overlap areas and/or waypoints.

At step 364, the response is received at the wireless electronic device.

With continued reference to FIG. 5, at step 304, the broadcast management function 118 tunes the communication circuitry 102 of the wireless electronic device 100 to the channel in the station list associated with the current location of the wireless electronic device 100. Although in some embodiments, the wireless electronic device 100 may already be tuned to this channel.

At step 306, the broadcast management function 118 of the wireless electronic device 100 determines whether the station list includes a waypoint. If the station list does not include a waypoint (i.e., the planned travel route is within the broadcast area of a single channel), the process ends at step 314. If the station list does include a waypoint such that the planned travel route is within two or more broadcast areas (e.g., 12a, 12b), then the process proceeds to step 308, where the broadcast management function 118 of the wireless electronic device 100 determines whether the device has moved to a waypoint.

The determination of whether the device has moved to a waypoint may be based on the location of the wireless electronic device 100 (e.g. as determined by the position data receiver 134) and information included in the station list. The station list may include the location of a waypoint for each overlap area 13. In one embodiment, the location of the waypoint may be based on the predicted signal strength of two or more transmitters, or the location of the waypoint may be middle of the overlap area 13. When the device traveling along the planned travel route reaches the waypoint, the wireless electronic device 100 may switch channels from the channel presently being received to the new channel (step 310). In another embodiment, the location of the waypoint may be the border of the overlap area 13. When the wireless electronic device 100 enters the overlap area 13, the wireless electronic device 100 monitors signal strength values (e.g., received signal strength indicator RSSI) of the corresponding transmitters and, when the actual signal strength of the transmitter associated with the channel presently being received is less than the actual signal strength of the transmitter associated with a new channel, the wireless electronic device 100 may switch channels to the new channel (step 310).

At step 312, the broadcast management function 118 determines whether the station list includes an additional waypoint. If the station list does not include an additional waypoint, the process ends at step 314. If the station list does include an additional waypoint, the process returns to step 308 where the broadcast management function 118 of the wireless electronic device 100 determines whether the wireless electronic device 100 has moved to a waypoint.

The example described with respect to FIGS. 4-7 describes the content of the specified broadcast as content affiliated with a single network. The content of the specified broadcast may be affiliated with a genre of programming. For example, the genre of the specified broadcast may be news. In some embodiments, if the wireless electronic device 100 is moved to a new location and can no longer receive the specified broadcast, then the broadcast management function 118 may tune the communication circuitry 102 of the wireless electronic device 100 to a another content within the same genre (e.g., news). Accordingly, even if the content being broadcast by the first station is not available in the second location, the wireless electronic device 100 may receive a similar broadcast. In other embodiments, the broadcast management function 118 may determine the station list based on genre. For example, the generated station list may include a first station broadcasting a first news program at a first location and a second station broadcasting a second news program at a second location.

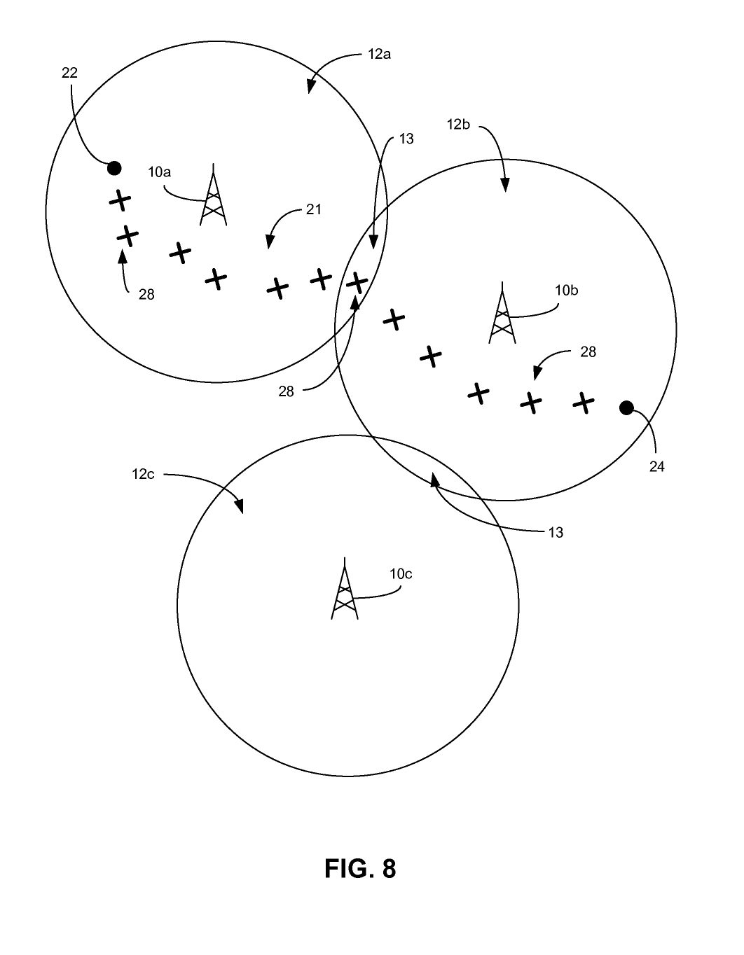

With reference to FIGS. 8-10, another exemplary embodiment is described for managing receipt of the broadcast in an ad hoc manner. In such embodiments, the route to be traveled is not known to the wireless electronic device, but receipt of the specified broadcast is maintained as the wireless electronic device travels. FIG. 8 shows an arrangement of broadcast areas similar to that shown in FIG. 4. The wireless electronic device 100 moves within the broadcast environment. But in FIG. 8, a planned travel route is not determined prior to movement of the wireless electronic device 100. For purposes of description, however, the electronic device 100 moves from the exemplary starting point 22 to the exemplary ending point 24.

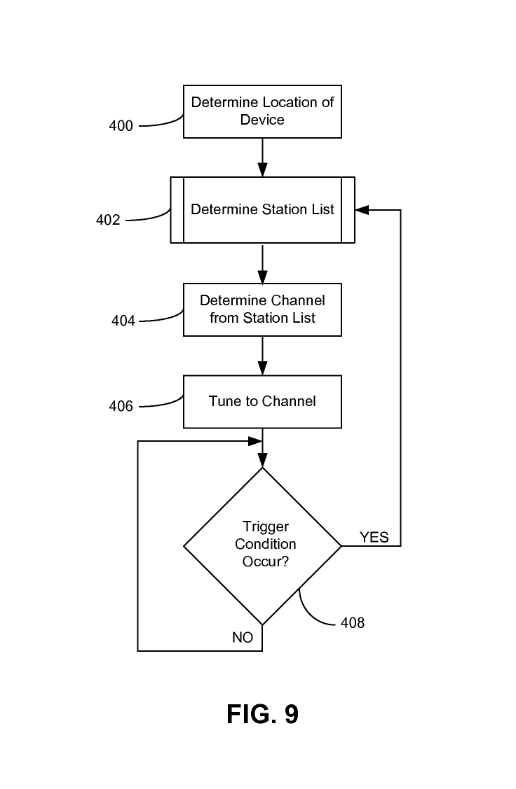

With additional reference to FIG. 9, the exemplary broadcast management process may commence in block 400 where the current location of the wireless electronic device is determined. In one exemplary embodiment, the location of the wireless electronic device may be determined using the GPS of the wireless electronic device 100. The location of the wireless radio device 100 may be determined using a triangulation method.

At step 402, the broadcast management function 118 of the wireless electronic device 100 determines the station list using a current location of the wireless electronic device. The station list may be a list of channel numbers associated with transmitters within a predetermined distance from the current location of the wireless electronic device 100. The predetermined distance may be any suitable distance. Defining the predetermined distance allows for channel numbers and associated locations that will likely not be used due to their geographic location relative to the wireless electronic device to be omitted from the station list. This predetermined distance may be defined by the user of the wireless electronic device, or may be automatically defined by the wireless electronic device 100 or server 202. An exemplary predetermined distance is 10 kilometers.

In one embodiment, determination of the station list is performed at the wireless electronic device 100. Specifically, the broadcast management function 118 of the wireless electronic device 100 determines the specified broadcast that is to be received by using the database 122 of the wireless radio device 100 using information such as the channel that the wireless electronic device is tuned to at the current location, the selection of a channel or network using a content guide (e.g., stored in the database 122 or made available by a third party), etc.

The broadcast management function 118 uses the database 122 to determine a network identity associated with the determined specified broadcast. For example, it may be identified that NBC is the network affiliated with the specified broadcast. The broadcast management function 118 then uses the database 122 to determine the channel(s) associated with transmitters affiliated with the determined network (e.g., NBC) and/or broadcasting the specified broadcast within a predetermined distance from the wireless electronic device 100. As shown in FIG. 8, the specified broadcast is provided on three different channels at different locations. In other embodiments not specifically shown, the specified broadcast may be provided on two channels in the same coverage area. For example, the same program may be broadcast using both a mobile TV standard and a fixed TV standard. The broadcast management function may also use the database 112 to identify the overlap area(s) 13 (FIG. 8), which represents the overlap in the coverage area of the signals from two or more transmitters that broadcast the specified broadcast.

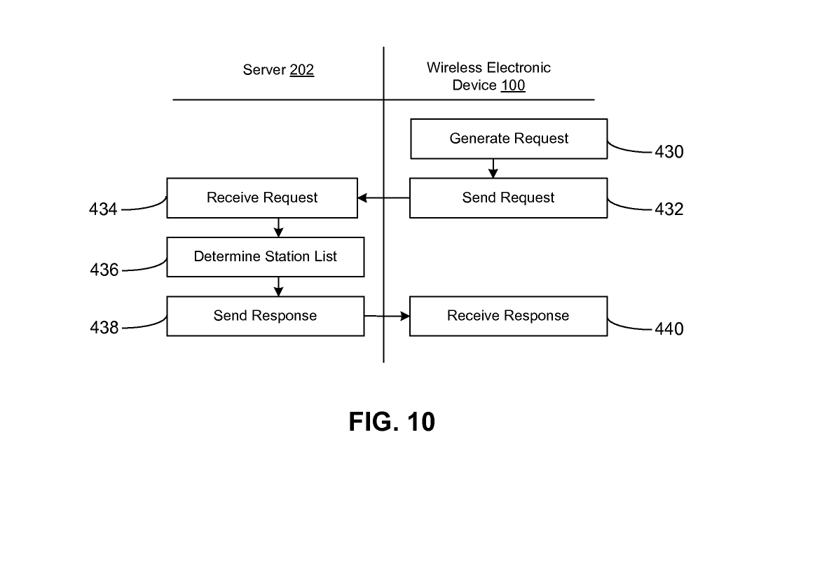

FIG. 10 shows another embodiment in which the step of determining the station list 402 is performed using the server.

At step 430, the broadcast management function 118 of the wireless electronic device 100 generates a request for a station list. The request may include information to enable the server 202 to generate the station list. For example, the request may include information such as the current location of the wireless electronic device 100. The request may additionally include one or more of identification information of the wireless electronic device 100, one or more operating parameters of the wireless electronic device 100, information to identify the specified broadcast (e.g., a selection from a content guide hosted by the server, the wireless electronic device, or a third-party system; a selected channel or network; or the channel or network that the wireless electronic device is tuned to at the current location), information regarding the predetermined distance, etc. The request is sent by the wireless electronic device at step 432, and the request is received at the server 202 at step 434.

At step 436, the broadcast determination function 220 uses the database 224 and the current location of the wireless electronic device 100 to determine the channel(s) associated with transmitters broadcasting the content within a predetermined distance from the wireless electronic device 100. This determination may also be made using any additional information provided in the request. The broadcast determination function 220 may also use the database 112 to identify the overlap area(s) 13 (FIG. 8), which represents the overlap in the coverage area of the signals from two or more transmitters that broadcast the specified broadcast.

The process proceeds to step 438 where the response is sent to the wireless electronic device 100. The response may include the station list. At step 440, the response is received at the wireless electronic device.

With continued reference to FIG. 9, at step 404, the broadcast management function 118 of the wireless electronic device 100 determines a channel from among the channel(s) identified in the station list. When the wireless electronic device is located in an area with only one channel from the station list, such channel is chosen. When the wireless electronic device is located in an overlap area 13, the determination is based on signal strength of the overlapping channels from the station list. In one embodiment, the determination is made using predicted signal strength of the transmitters at the present location. Predicted signal strength may be determined using any appropriate path loss model, such as Longley-Rice, F-curves, etc. The channel associated with the greater signal strength is chosen. In another embodiment, the determination is made using actual signal strength of the transmitters at the present location. The wireless electronic device 100 may determine signal strength values (e.g., received signal strength indicator RSSI) of the corresponding transmitters and choose the channel associated with the greatest signal strength. When the specified broadcast is provided on two channels in the same coverage area broadcasting using different broadcast standards (e.g., using a mobile TV standard on one channel and a fixed TV standard on another channel), the broadcast management function 118 may prioritize one broadcast over another (e.g., the mobile TV standard over the fixed TV standard).

At step 406, broadcast management function 118 tunes the communication circuitry 102 of the wireless electronic device 100 to the channel in the station list associated with the current location of the wireless electronic device 100. Although in some embodiments, the wireless electronic device 100 may already be tuned to this channel.

At step 408, a determination is made as to whether a trigger condition has occurred. The trigger condition may be at least one of temporal or geographical in nature. For example, the trigger condition may occur every time the wireless electronic device enters travels a specified distance. The position of the wireless electronic device and the distance that the wireless electronic device travels may be monitored by the position data receiver 134. In another example, the trigger condition may occur after a predetermined amount of time has elapsed. If the result of the determination is that the trigger condition has not occurred (NO), the process returns to step 408. If the result of the determination is that the trigger condition has occurred (YES), the process returns to step 404 where the broadcast management function 118 of the wireless electronic device 100 determines a channel from among the channel(s) identified in the station list. FIG. 8 shows an example of locations 28 along the path 21 a trigger condition occurs.

The example described with respect to FIGS. 8-10 describes the content of the specified broadcast as content affiliated with a single network. The content of the specified broadcast may be affiliated with a genre of programming. For example, the genre of the specified broadcast may be news. In some embodiments, if the wireless electronic device 100 is moved to a new location and can no longer receive the specified broadcast, then the broadcast management function 118 may tune the communication circuitry 102 of the wireless electronic device 100 to a another content within the same genre (e.g., news). Accordingly, even if the content being broadcast by the first station is not available in the second location, the wireless electronic device 100 may receive a similar broadcast. In other embodiments, the broadcast management function 118 may determine the channel based on genre. For example, the broadcast management function 118 may tune the communication circuitry 102 of the wireless electronic device 100 to a first station broadcasting a first news program at a first location, and may tune the communication circuitry 102 of the wireless electronic device 100 to a second station broadcasting a second news program at a second location.

In the above-described exemplary embodiments, the wireless electronic device 100 and/or the server 202 manage broadcast reception of a specified broadcast for continuity in reception even if the wireless electronic device moves. In other embodiments, the wireless electronic device 100 and/or the server 202 may manage broadcast reception by managing the receipt or display of certain channels, such as permission-based channels.

In some embodiments, the permission management function 120 of the wireless electronic device 100 may manage the communications circuitry 102 so that it can only tune to or decode permitted channels. Permitted channels include two categories of channels. The first category includes channels to which any compatible device is allowed to access, such as free over-the-air channels to which any tuner is permitted to tune and decode. The second category includes channels of permission-based programming broadcast using private network equipment on TVWS channels, licensed channels, or other channels on which free or unrestricted access is not required by governing regulation, but that the device has permission to access, such as through a subscription or pay-per-view. In one embodiment, the ability to tune to a channel having a permission-based broadcast is controlled and requires an authenticated data object, e.g., a digital key stored in the database 122 of the wireless electronic device 100 or in the database 224 of the server 202.

In other embodiments, the permission-based broadcast is freely received by any compatible radio device, but is encrypted. Decryption of the broadcast requires a decryption key (e.g., stored in the database 122 of the wireless electronic device 100 or in the database 224 of the server 202). In one example, the permission management function 120 of the wireless electronic device 100 may request the decryption key from the server 202, and the permission determination function 122 of the server 202 may determine, e.g., using the database 224, whether the wireless electronic device 100 is permitted to access the permission-based broadcast. If the wireless electronic device 100 is permitted to access the permission-based broadcast, the permission determination function 122 of the server 202 may provide the decryption key to the wireless electronic device 100 for use in decrypting the encrypted channel. The decryption key may have a temporal lifespan, and may be stored in the database 122 of the wireless electronic device 100 for the life of the decryption key. If the wireless electronic device 100 is not permitted to access the permission-based broadcast, the permission determination function 222 of the server may not provide a decryption key to the wireless electronic device 100. The permission determination function 222 may instead provide a notification that access to the encrypted channel is denied.

### E. CONCLUSION

Although certain embodiments have been shown and described, it is understood that equivalents and modifications falling within the scope of the appended claims will occur to others who are skilled in the art upon the reading and understanding of this specification.

What is claimed is:

1. A wireless electronic device, comprising:
communications circuitry configured to tune to a specified broadcast;
control circuitry that executes a broadcast management function configured to:
determine a station list for the specified broadcast, the station list comprising a first channel of a first station on which the specified broadcast is broadcast at a first location and a second channel of a second station on which the specified broadcast is broadcast at a second location;
control the communication circuitry in accordance with the station list so as to tune the communication circuitry to the first channel in the first location and receive the specified broadcast;
control the communication circuitry in accordance with the station list so as to retune the communication circuitry to the second channel in the second location to continue reception of the specified broadcast.

2. The wireless electronic device of claim 1, wherein the control of the communication circuitry in accordance with the station list so as to retune the communication circuitry to the second channel comprises:
detecting arrival of the wireless electronic device at a waypoint between the first location and the second location; and
controlling the communication circuitry in accordance with the station list so as to retune the communication circuitry to the second channel in response to the detection.

3. The wireless electronic device of claim 2, wherein the waypoint between the first location and the second location is determined using a predicted signal strength of the first channel and a predicted signal strength of the second channel.

4. The wireless electronic device of claim 2, wherein the waypoint between the first location and the second location is a middle of an overlap area of the first channel and the second channel.

5. The wireless electronic device of claim 1, wherein the control of the communication circuitry in accordance with the station list so as to retune the communication circuitry to the second channel comprises:
detecting arrival of the wireless electronic device at a waypoint between the first location and the second location, the waypoint being a border of an overlap area of the first channel and the second channel;
controlling the communication circuitry in accordance with the station list so as to detect an actual signal strength of the first channel and an actual signal strength of the second channel; and
controlling the communication circuitry to retune to the second channel when the actual signal strength of the second channel is greater than the actual signal strength of the first channel.

6. The wireless electronic device of claim 1, further comprising a memory storing a database of broadcast channels and coverage areas for each of the broadcast channels, and
wherein the broadcast management function is configured to determine the station list by searching the database.

7. The wireless electronic device of claim 6, wherein the determination of the station list is carried out in advance of movement of the wireless electronic device using a planned travel route of the wireless electronic device from a starting point to an ending point.

8. The wireless electronic device of claim 6, wherein the determination of the station list is carried out in advance of movement of the wireless electronic device using a current location of the wireless electronic device.

9. The wireless electronic device of claim 6, wherein the database of the wireless electronic device is periodically updated using a database stored on a server

10. The wireless electronic device of claim 1, wherein the broadcast management function is configured to determine the station list by:
transmitting a request for the station list for the specific broadcast to a server and;
receiving the station list from the server.

11. The wireless electronic device of claim 10, wherein the determination of the station list is carried out in advance of movement of the wireless electronic device, and the request comprises a planned travel route of the wireless electronic device from a starting point to an ending point.

12. The wireless electronic device of claim 10, wherein the determination of the station list is carried out in advance of movement of the wireless electronic device and the request comprises a current location of the wireless electronic device.

13. A server, comprising:
communications circuitry configured to communicate with a wireless electronic device;
a memory storing a database of channels associated with a specified broadcast and coverage areas for each of the channels; and
control circuitry that executes a broadcast determination function configured to:
receive a request for a station list for a specified broadcast from the wireless electronic device;
determine the station list for the specified broadcast in accordance with the database, the station list comprising a first channel of a first station on which the specified broadcast is broadcast at a first location and a second channel of a second station on which the specified broadcast is broadcast at a second location; and
send the station list to the wireless electronic device.

14. The server of claim 13, wherein the control circuitry is further configured to execute the broadcast determination function to determine a waypoint between the first location and the second location.

15. The server of claim 14, wherein the waypoint between the first location and the second location is determined using a predicted signal strength of the first channel and a predicted signal strength of the second channel.

16. The server of claim 14, wherein the waypoint between the first location and the second location is a middle of an overlap area of the first channel and the second channel.

17. The server of claim 14, wherein the waypoint between the first location and the second location is a border of an overlap area of the first channel and the second channel

18. The server of claim 13, wherein the request comprises a planned travel route of the wireless electronic device from a starting point to an ending point.

19. The server of claim 13, wherein the request comprises a current location of the wireless electronic device.

20. A method of managing receipt of a broadcast for a wireless electronic device, comprising:
determining a station list for a specified broadcast, the station list comprising a first channel of a first station on which the specified broadcast is broadcast at a first location and a second channel of a second station on which the specified broadcast is broadcast at a second location;
tuning communication circuitry of the wireless electronic device in accordance with the station list to the first channel in the first location and receiving the specified broadcast;
retuning the communication circuitry to the second channel in the second location to continue reception of the specified broadcast.

21. The method of claim 20, wherein the retuning the communication circuitry to the second channel comprises:
detecting arrival of the wireless electronic device at a waypoint between the first location and the second location; and
retuning the communication circuitry to the second channel in response to the detection.

22. The method of claim 20, wherein the retuning the communication circuitry to the second channel comprises:
detecting arrival of the wireless electronic device at a waypoint between the first location and the second location;
controlling the communication circuitry in accordance with the station list so as to detect an actual signal strength of the first channel and an actual signal strength of the second channel; and
controlling the communication circuitry to retune to the second channel when the actual signal strength of the second channel is greater than the actual signal strength of the first channel.

23. The method of claim 20, wherein the determination of the station list is carried out in advance of movement of the wireless electronic device using a planned travel route of the wireless electronic device from a starting point to an ending point.

24. The method of claim 20, wherein the determination of the station list is carried out in advance of movement of the wireless electronic device using a current location of the wireless electronic device.

25. The method of claim 20, wherein the determination of the station list further comprises:
transmitting a request for the station list for the specific broadcast to a server and;
receiving the station list from the server.

26. A method of managing receipt of a broadcast for a wireless electronic device, comprising:
receiving a request for a station list for a specified broadcast from the wireless electronic device;
determining the station list for the specified broadcast using the database, the station list comprising a first channel of a first station on which the specified broadcast is broadcast at a first location and a second channel of a second station on which the specified broadcast is broadcast at a second location; and
sending the station list to the wireless electronic device.

27. The method of claim 26, further comprising determining a waypoint between the first location and the second location.

28. The method of claim 26, wherein the request comprises a planned travel route of the wireless electronic device from a starting point to an ending point.

29. The method of claim 26, wherein the request comprises a current location of the wireless electronic device.

30. A wireless electronic device, comprising:
communications circuitry configured to tune to a specified broadcast; and
control circuitry that executes a broadcast management function configured to determine available broadcasts and associated channel numbers for a given location of the wireless electronic device from a database of broadcast channels and coverage areas for each of the broadcast channels.

31. The wireless electronic device of claim 30, further comprising a memory storing the database, and
wherein the broadcast management function is configured to determine the available broadcasts and associated channel numbers for a given location of the wireless electronic device by searching the database.

32. The wireless electronic device of claim 30, wherein the broadcast management function is configured to determine the available broadcasts and associated channel numbers for a given location of the wireless electronic device by:
transmitting a request for the available broadcasts and associated channel numbers for a given location to a server; and
receiving a list of the available broadcasts and associated channel numbers from the server.

33. A server, comprising:
communications circuitry configured to communicate with a wireless electronic device;
a memory storing a database of channel numbers associated with a specified broadcast and coverage areas for each of the channels; and
control circuitry that executes a broadcast determination function configured to:
receive a request for the available broadcasts and associated channel numbers for a given location from the wireless electronic device;
determine the available broadcasts and associated channel numbers for a given location of the wireless electronic device by searching the database; and
send a list of the available broadcasts and associated channel numbers to the wireless electronic device.
